(19) United States
(12) Patent Application Publication
(10) Pub. No.: US 2007/0268778 A1
(43) Pub. Date: Nov. 22, 2007

(54) Aggregate preheating system, kit and method

(76) Inventor: Wesley Van Velsor, Charlestown, NH (US)

Correspondence Address: Michael J. Persson;Lawson & Persson, P.C., Suite 103, 67 Water Street, Laconia, NH, 03246, US

(21) Appl. No.: 11/805,021

(22) Filed: May 22, 2007

Related U.S. Application Data
(60) Provisional application No. 60/802,360, filed on May 22, 2006.

(51) Int. Cl. B28C 5/46

(52) U.S. Cl. 366/7; 366/22; 366/49

(57) ABSTRACT

A system, kit and method for preheating aggregate supplied to a drying drum uses in the HMA manufacturing process. The system includes a conveyor belt, at least one infrared chamber disposed in substantially parallel relation to the conveyor belt at a distance sufficient to allow infrared heating of the aggregate material, a source of fuel, a fuel control in communication with the infrared chamber, and at least one mixer disposed between the infrared chamber and the conveyor belt and dimensioned and disposed relative to the conveyor belt so as to mix the aggregate material during pre-drying.

### CLAIM OF PRIORITY

This application claims the benefit of priority of U.S. Provisional Patent Application Ser. No. 60/802,360, filed on May 22, 2006.

### FIELD OF THE INVENTION

The present invention relates to the field of asphalt manufacturing and, in particular, to an aggregate preheating system for preheating aggregate being conveyed into drying drums during the asphalt manufacturing process.

### BACKGROUND OF THE INVENTION

The raw material for roadway asphalt, known in the industry as Hot Mix Asphalt (“HMA”), is usually prepared at a batch plant. In addition to the asphalt oil itself, HMA includes an aggregate, which is typically a mixture of sand, small rocks, and other filler material, such as shredded rubber tires, or may be recycled asphalt pavement that is crushed into small pieces. This aggregate used in the manufacturing process invariably has moisture entrapped therein, which must be removed before the asphalt oil is added.

Conventional HMA plants include a conveyor belt upon which aggregate is conveyed into a rotating drying drum, which may include impellers to lift the aggregate to assist in the drying process. The drum is typically rotated and heated to a very high temperature. Heating is typically accomplished by firing an oil burner and using a fan located adjacent to the drum to direct a flow of hot air into the drum. The aggregate is tumbled in the hot air flow by the rotation of the drum, and by the impellers lifting the aggregate and dropping it into the air stream, essentially drying and heating the aggregate. Once the aggregate is heated to a desired temperature, typically in the range of 120 to 180 degrees Centigrade, the aggregate is sufficiently dried and a flow of hot liquid asphalt is introduced to the aggregate, and mixed therewith, producing the finished HMA.

The process employed by conventional HMA plants is effective at drying and heating the aggregate and generally produces an acceptable end product. However, this process has three substantial drawbacks.

First, the burners used to heat the aggregate during the drying and preheating process use an enormous amount of fuel, which is costly both in terms of purchasing the oil and in terms of controlling the emissions produced thereby. Therefore, the longer these burners are forced to run, the greater the expense of producing the HMA. Unfortunately, even with the use of impellers to mix the aggregate during drying, bulk drying of the entire batch of aggregate at one time is inefficient and results in the burners being fired for a significant period of time to effect drying, resulting in a significant amount of expensive fuel being used.

Second, the longer the drying process takes, the fewer batches of HMA that may be produced. Because the equipment used in HMA production is very expensive, and because the demand for HMA is such that all batches produced by a given plant would be readily sold, increasing the rate at which batches of HMA may be processed will greatly increase the profits for HMA manufacturers.

Third, the amount of aggregate used in the each batch produced by the HMA manufacturing process is typically measured by the weight of the aggregate in the drying drum. Therefore, variations in the moisture content of the aggregate can cause the amount of aggregate to be too low. Thus, the manufacturer is forced to either live with these variations, resulting in batch-to-batch inconsistencies of the HMA produced, or to add more wet aggregate to the drum, which further increases the amount of fuel used and drying time.

In addition to HMA, a number of companies have recently developed formulations for warm melt asphalt (WMA) to replace traditional HMA. WMA is manufactured using a process similar to HMA, but uses different formulations of aggregate and asphalt additives that are each mixed at lower temperatures than HMA. Switching from HMA to WMA reduces the amount of fuel used in the manufacturing process, as it is heated to lower temperatures than HMA, and allows the use of certain additives that cannot withstand the temperatures required during the production of HMA. Further, WMA has been found to reduce the curing time of the asphalt, allowing a shorter period of time between laying the asphalt surface and allowing the pavement to be used.

A number of tests on WMA have produced encouraging results. However, a recent report by the National Center for Asphalt Technology cautioned that the moisture content of the mix is an important consideration and cites the potential for moisture damage due to too much water left in close content with the aggregate. Thus, there is a need for a means for pre-drying the aggregate used in WMA production in order to reduce the chance of moisture damage.

Therefore, there is a need for a system and method for reducing the amount of fuel consumed to dry and preheat the aggregate used in the asphalt manufacturing process, for reducing the amount of time that it takes to dry and preheat the aggregate used in the asphalt manufacturing process, to increase the accuracy of the amount of aggregate used in the asphalt manufacturing process in order to increase the batch to batch consistency of the asphalt produced thereby without the need to add wet aggregate to the batch during drying and preheating, and to reduce the risk of moisture damage due to the presence of excess moisture in aggregate used in the production of warm melt asphalt.

### SUMMARY OF THE INVENTION

The present invention is system, kit and method for pre-drying aggregate supplied to a drying drum uses in the HMA manufacturing process. In its most basic form, the system includes a conveyor belt in communication with a source of the aggregate material, at least one infrared chamber, a source of fuel, and at least one mixer disposed between the infrared chamber and the conveyor belt. The conveyor belt is preferably manufactured of a rubberized material that is adapted to convey said aggregate material at a predetermined rate. The infrared chamber, or chambers, is disposed in substantially parallel relation to the conveyor belt at a distance sufficient to allow infrared heating of the aggregate material. The fuel source is preferably a gaseous fuel, such as propane, that is in communication with the infrared chamber. The mixer is dimensioned and disposed relative to the conveyor belt so as to mix the aggregate material during pre-drying.

In operation the conveyor belt conveys the aggregate material from its source and under the infrared chamber at a predetermined rate. The fuel flows to the infrared chamber, which bums the fuel causing the infrared chamber to emit infrared radiation therefrom. The infrared radiation contacts the top surface of the aggregate that is conveyed on the conveyor belt and acts to heat the top portion of the aggregate material proximate to said infrared chamber. The mixer then mixes the aggregate material such that heated and unheated aggregate material are mixed together, allowing the unheated aggregate material proximate to the conveyor belt to rise to the top surface proximate to the infrared chamber. The infrared radiation from the infrared chamber then heats the mixed aggregate material to effectively pre-heat and pre-dry the aggregate material.

The preferred system includes a control box in electrical communication with the infrared chamber and the source of fuel. The control box includes controls for controlling the flow of fuel from the source of fuel to the infrared chamber.

The preferred system also includes at least one blower motor in communication with the control box, the source of fuel, a source of air, and the infrared chamber. The blower motor is controlled by the control box and is adapted to mix fuel and air together and force the mixture of fuel and air into the infrared chamber. The use of a blower motor is preferred as it allows the infrared chamber to consistently produce a greater amount of heat than may be produced by relying upon the pressure from the source of fuel.

The preferred system also includes at least one igniter in communication with the infrared chamber. The igniter is adapted to ignite the fuel within the infrared chamber so that it may be burned and turned into infrared radiation. In some embodiment of the system, there are multiple infrared chambers and a single igniter is used to ignite the fuel within each of these chambers. This igniter is an elongate tube that extends through each chamber, is itself in communication with the source of fuel, and operates in a manner similar to a conventional pilot light. The use of a single igniter is preferred as it reduces the overall cost and complexity of the system. However, the preferred embodiment utilizes multiple igniters, which are each in communication with a single infrared chamber and are independently controlled by the control box. In still other embodiments, there are no igniters and an operator ignites the fuel within the infrared chambers manually.

The preferred system includes at least three, and preferably eight infrared chambers. The preferred infrared chambers include a top portion that allows moisture to escape through the top of the chamber. In a preferred embodiment the top portion of the infrared chamber is manufactured of a material, preferably expanded metal, which allows for the escape of such moisture. However, in other embodiments, the chamber includes a plurality of holes formed therethrough to allow such moisture to be vented.

In embodiments for use with non-recycled asphalt, the infrared chambers are preferably disposed in a row over the conveyor belt such that each infrared chamber is disposed relative to an adjacent infrared chamber so as to form a gap therebetween. In these embodiments, one mixer is preferably disposed within each gap, and additional mixers are disposed within the infrared chambers between individual infrared converts disposed therein at a spacing of approximately twelve inches. Such mixers preferably include a plurality of tines forming a plurality of spaces therebetween, and each is dimensioned and disposed within each gap such that each tine of one mixer is aligned with a space of adjacent mixers. In this manner, the aggregate is thoroughly mixed rather than just having the areas adjacent to the tines mixed.

The mixer of the preferred system for use with non-recycled asphalt includes a channel, and a plurality of tines rotatably attached to the channel. The tines are in communication with at least one spring and are disposed in sufficiently close proximity to the conveyor belt so as to contact said aggregate material conveyed by said conveyor belt. The spring allows the tines to flex while preventing them from becoming entangled with the conveyor belt. In the preferred embodiment, the tines are joined together into a rake and a single spring is used to maintain the tines in position. However, in other embodiments, each tine is independent form the other tines and is in communication with its own spring. In still other embodiments, the mixer is not a series of tines, but rather is a toothed roller disposed across the conveyer belt and adapted to mix the aggregate.

The mixer of the preferred system for use with recycled asphalt is a series of ramps that are disposed proximate to the conveyor belt. Each ramp has a ramp surface that is disposed at an angle from plane formed by the conveyor belt and is dimensioned to allow the asphalt aggregate to pushed up the ramp by aggregate that is in contact with the conveyor belt and to tumble back onto the belt, effectively mixing the aggregate.

Finally, some embodiments of the system of the present invention include at least one hygrometer and/or thermometer for determining the moisture content and/or temperature of the aggregate at least at the start of the preheating process. In such embodiments, the hygrometers and/or thermometers are preferably in communication with a conveyor control, which slows the conveyor belt or speeds up the conveyor belt based upon the amount of moisture within the aggregate. Thus use of such a control is preferred in when the system is used in connection with warm melt asphalt manufacturing as it allows for careful control of the amount of moisture while maximizing the speed of the process in instances where there are minimal amounts of moisture within the aggregate.

The preheating kit of the present invention includes the infrared chamber and the mixer and is adapted to be installed in asphalt manufacturing plants with existing conveyor belts. Other embodiments of the preheating kit may include any of the options discussed above in connection with the system, and may also include a source of fuel.

The invention also includes a method for pre-drying an aggregate material for use in an asphalt manufacturing process. In its most basic form, the method includes the steps of conveying an aggregate material under a source of infrared radiation, first heating a portion of said aggregate material using infrared radiation, mixing said heated portion of said aggregate material with an unheated portion of said aggregate material, and second heating said mixed aggregate material.

The preferred method includes eight heating steps and six mixing steps. Some embodiments of the method also include the steps of measuring the moisture content and/or temperature of the aggregate and controlling the speed of the conveyor belt based upon a result of the measuring step.

Therefore, it is an aspect of the invention to provide a system and method for reducing the amount of fuel consumed to dry the aggregate used in the HMA manufacturing process.

It is a further aspect of the invention to provide a system and method for reducing the amount of time that it takes to dry the aggregate used in the HMA manufacturing process.

It is a further aspect of the invention to provide a system and method to increase the accuracy of the amount of aggregate used in the HMA manufacturing process in order to increase the batch to batch consistency of the HMA produced thereby without the need to add wet aggregate to the batch during drying.

It is a further aspect of the invention to provide a system and method to reduce the risk of moisture damage due to the presence of excess moisture in aggregate used in the production of warm melt asphalt.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a side view of one embodiment of the system of the present invention.

FIG. 2 is a side view of one embodiment of the mixer of the system of the present invention.

FIG. 3 is a front view of the embodiment of the mixer of FIG. 2 with springs omitted.

FIG. 4 is a top view of one embodiment of the system with infrared chambers omitted to show the relation between the tines of the preferred mixers.

FIG. 5 is a top view of one embodiment of the system with the infrared chambers cut away to show the preferred igniter and an alternative embodiment of the mixer.

FIG. 6A is a side view of the preferred embodiment of the system of the present invention.

FIG. 6B is a bottom view of system of FIG. 6A with the conveyor belt omitted to show the relationship between the tines of the preferred mixer and: the infrared converters of the preferred infrared chamber.

FIG. 7 is a side view of a preferred embodiment of the system of the present invention for use with recycled asphalt that utilizes multiple conveyor belts to tumble the aggregate and tines to mix the tumbled aggregate.

FIG. 8 is a side view of an alternative embodiment of the system for use with recycled asphalt that utilizes ramps to tumble the aggregate.

### DETAILED DESCRIPTION OF THE INVENTION

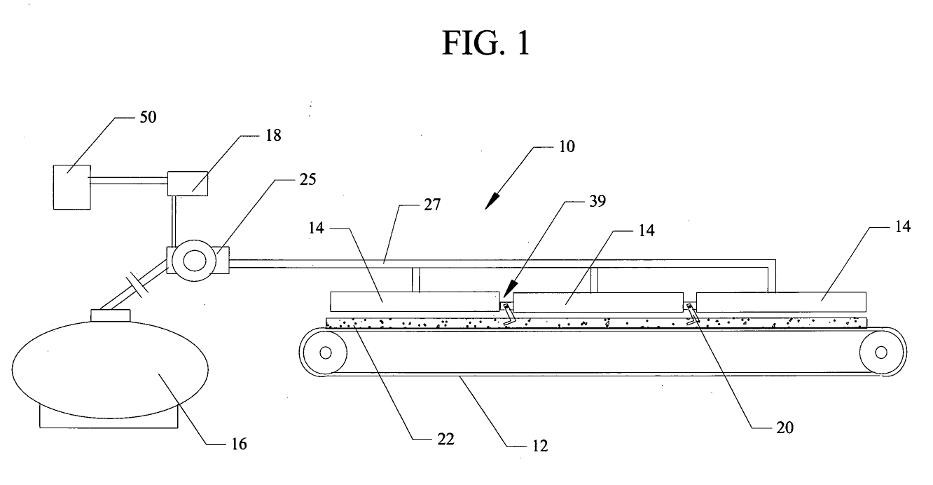

Referring first to FIG. 1, side view of one embodiment of the system 10 of the present invention is shown. The system 10 includes a conveyor belt 12 in communication with a source (not shown) of the aggregate material 22. The conveyer belt 12 preferably takes the form of conveyor belts currently used to transport aggregate material in conventional HMA and WMA manufacturing processes. The belt may be manufactured of a non-combustible material, such as steel, but is preferably a composition belt manufactured of a rubberized material. Such a material is preferred due its gripping properties and price. The conveyor belt 12 is adapted to convey the aggregate material 22 at a predetermined rate from the source to another location, such as a rotating drying drum (not shown). As shown in FIG. 1, the conveyor belt 12 is in a substantially horizontal position. However, the conveyor belt 12 may be inclined at up to a four to one incline and still effectively convey the aggregate material 22. As discussed below, the conveyor belt 12 may include controls to allow the rate of the conveyor belt 12 to be varied based upon the moisture content or temperature of the aggregate material 22.

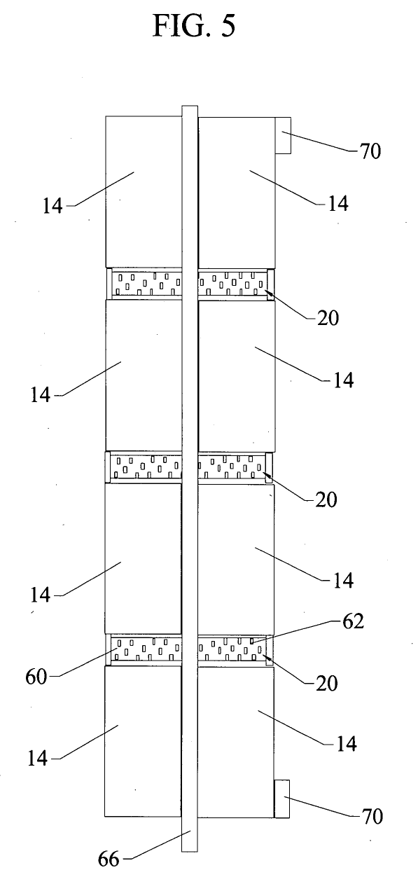

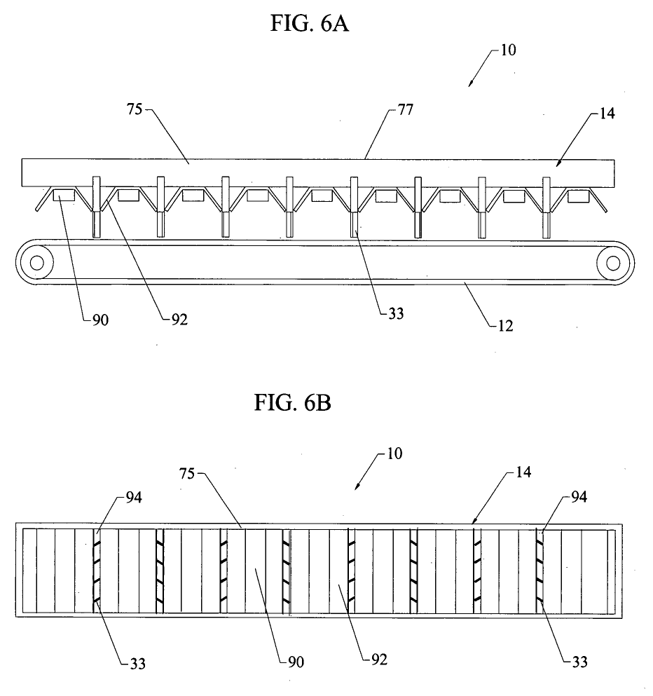

The system 10 also includes at least one infrared chamber 14. In the embodiment of FIG. 1, the system 10 includes three infrared chambers 14 that are disposed adjacent to one another along the conveyor belt. However, in other embodiments of the system 10, more or fewer infrared chambers 14 may be utilized. As shown in FIGS. 6A and 6B, each infrared chamber 14 preferably contains eight infrared energy converters 90. These infrared energy converters 90 are preferably of the type manufactured by Ray-Tech Infrared Corporation of Charlestown, N.H., and described in connection with the inventor's U.S. Pat. No. 6,227,762. The infrared chambers 14 are mounted in substantially parallel relation to the conveyor belt 22 and are disposed a distance, preferably, four inches, sufficient to allow infrared radiation to penetrate into the aggregate material 22. The infrared chambers 14 are dimensioned to extend over the entire width of the conveyor belt 12 and are manufactured in different sizes to accommodate different widths of conveyor belts 12; typically thirty, thirty-six, sixty and seventy-two inches. As shown in FIG. 5, in instances where sixty or seventy-two inch wide conveyor belts 12 are utilized, two infrared chambers 14 may be mounted in side by side relation to one another to cover the width of the conveyor belt 12.

The infrared chambers 14 are in communication with a source of fuel 16, preferably propane or natural gas. In the embodiment of FIG. 1, fuel 16 is forced in the infrared chambers 14 by a blower motor 25. The blower motor 25 mixes propane fuel with air and delivers the mixture, under pressure, through the manifold 27 to the infrared converters in the chambers 14 to provide uniform heating. The preferred blower motor 25 also includes a shut off valve (not shown) to shut off the flow of fuel 16 to the infrared chambers 14. A control box 18, which is in electrical communication with the blower motor 24 and a source of power 50, preferably controls the operation of the blower motor 25. As described with reference to other embodiments, the control box 18 may also include other controls, such as ignition controls, and speed controls for the conveyor belt. The use of a blower motor 25 and control box 18 is preferred as it allows the infrared chamber 14 to consistently produce a greater amount of heat than may be produced by relying upon the pressure from the source of fuel 16. However, in other embodiments, both the blower motor 24 and control box 18 are eliminated and the flow of fuel 16 to the infrared chambers 14 is controlled via a manually operated valve (not shown), which opens to allow fuel 16 to flow solely via pressurization from the fuel source and is closed to shut off flow completely.

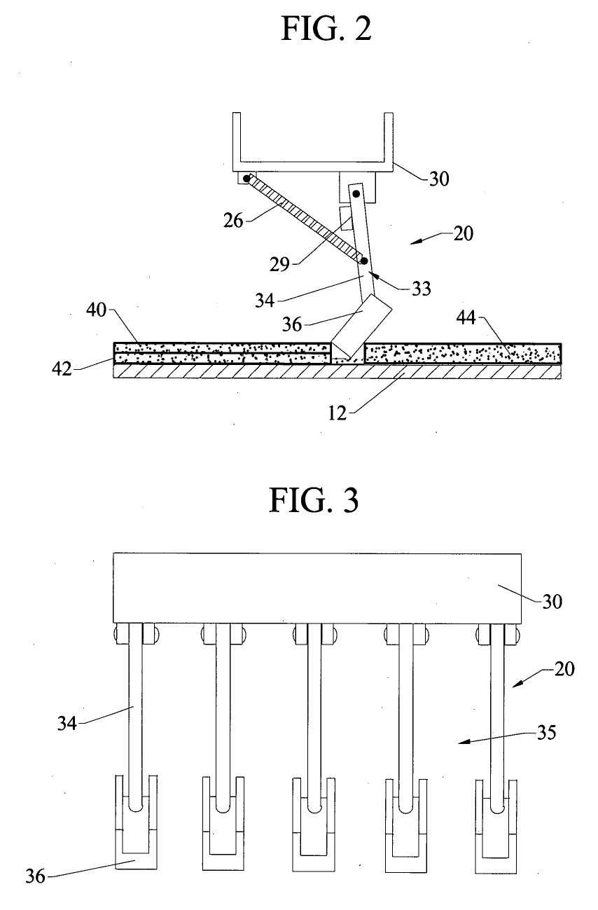

At least one mixer 20 is disposed between the infrared chambers 14 and the conveyor belt 12. The mixer 20 is dimensioned and disposed relative to the conveyor belt 12 so as to mix the aggregate material 22 during pre-drying. In the embodiment of FIGS. 2 and 3, the mixer includes a channel 30 that is secured to the infrared chambers 14 or another fixed location above the conveyor belt 12. A plurality of tines 33 are rotatably attached to the channel 30. In this embodiment, the tines 33 preferably include a substantially round rod 34 that extends downward and attaches to a short length of channel stock 36, which is angled downward therefrom. The channel stock 36 contacts the aggregate material 22 and mixes the hot top layer 40 with the cool lower layer 42 to form a substantially homogenous mixture 44. The tines 33 are in communication with at least one spring 26 and are disposed in sufficiently close proximity to the conveyor belt 12 so as to contact the aggregate material 22 conveyed by said conveyor belt. The spring 26 allows the tines 33 to flex while preventing them from becoming entangled with the conveyor belt. In the embodiment of FIG. 2 the tines are joined together via a cross bar 29 to form a rake 31 and a single spring 26 is used to maintain the tines 33 in position. However, in the embodiment s of FIG. 3, 6A and 6B, each tine 33 is independent form the other tines 33 and does not include any spring. In still other embodiments, the tines 33 are each independent and each is in communication with its own spring (not shown), preferably a coil type spring disposed about its pivot point.

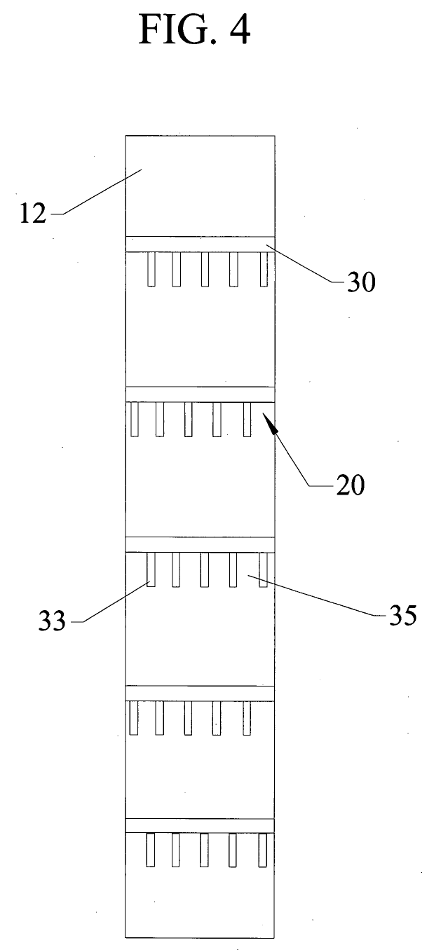

Referring again to FIG. 1, the preferred system 10 includes at least three, and preferably eight infrared chambers 14. These chambers 14 are disposed in a row over the conveyor belt 12 such that each infrared chamber 14 is disposed relative to an adjacent infrared chamber so as to form a gap 39 therebetween. In these embodiments, one mixer 20 is preferably disposed within each gap 39. As shown in FIG. 4, the mixers 20 preferably include a plurality of tines 33 forming a plurality of spaces 35 therebetween, and each is dimensioned and disposed within each gap 39 such that each tine 33 of one mixer 20 is aligned with a space 35 of adjacent mixers. In this manner, the aggregate material 22 is thoroughly mixed rather than just having the areas adjacent to the tines 33 mixed.

Referring now to FIGS. 6A and 6B, the preferred system 10 is shown. The preferred system 10 includes eight infrared energy converters 90 per infrared chamber 14. An angled reflector 92 is mounted about each infrared converter 90 such that the infrared energy generated by each converter is concentrated downward toward the conveyor belt 12. Each infrared energy converter 90 is arranged in a perpendicular orientation from the direction of travel of the conveyor belt 12 and each infrared energy converter 90 is spaced slightly apart from an adjacent infrared energy converter 90 in order to allow a mixer 20 to be disposed therebetween. In the preferred embodiment, the mixers 20 are disposed approximately twelve inches apart from each other to allow for substantially continuous mixing of the aggregate material 22. However, larger or smaller spacing may be utilized to achieve similar results.

The preferred mixer 20 includes a cross member 94 that attaches to the frame 75 of the infrared chamber 14 and a plurality of tines 33 that are fixedly attached thereto and extend downward toward the conveyor belt 12. The preferred cross member 94 is manufactured of steel and the tines 33 are likewise manufactured of steel and are welded to the cross member 94. As shown in FIG. 6B, the tines 33 are preferably arranged in an angled relationship along each cross member 94 such that the tine 33 attached to one cross member 94 are angled in an opposite direction from the tines 33 attached to an adjacent cross member 94. In this manner, the aggregate material (not shown) is continuously mixed on the conveyor belt. In FIG. 6B, the tines 33 are shown as being welded to the cross member 94 at an angle. Although such welding may be used, it is shown this way in FIG. 6B for the sake of clarity, as it is preferred that the tines be welded in a direction parallel to the direction of travel of the conveyor belt 12 and that the bottom half of each tine 33 be bent at an angle such that the bottoms of the tines 33 are arranged as shown in FIG. 6B. This attachment method is preferred as the perpendicular weld is better able to withstand the forces applied to each tine 33 than a weld at an angle.

As shown in FIG. 6A, the infrared chamber 14 includes a top portion 77 that is attachec to the frame 75 and disposed opposite the portion of the chamber 14 that is proximate to the conveyor belt 12. In the preferred embodiment of the system 10, this top portion 77 is designed to allow moisture to escape through the top portion 77 of the chamber 14. In a preferred embodiment the top portion 77 of the infrared chamber 14 is manufactured of a material, preferably expanded metal, which allows for the escape of such moisture. However, in other embodiments, the chamber 14 includes a plurality of holes (not shown) that are formed therethrough to allow such moisture to be vented.

Referring now to FIG. 5, another embodiment of the system 10 is shown. This embodiment shows an arrangement of eight infrared chambers 14 disposed in side by side relation. The mixers 20 in this embodiment are not hanging tines 20, but rather but rather is a roller 60 from which a series of teeth 62 extend. The roller 60 is disposed across the conveyer belt 12 and adapted rotate during operation such that the teeth 62 contact the aggregate material 22 and mix it together.

The embodiment of FIG. 5 also shows the preferred igniter 66. The igniter 66 is adapted to ignite the fuel 16 within each infrared chamber 14 so that it may be burned and turned into infrared radiation. In the system of FIG. 5, a single igniter 66 is used to ignite the fuel within each of the infrared chambers 14. This preferred igniter 66 is an elongate tube that extends through each chamber 14, is itself in communication with the source of fuel 16, and operates in a manner similar to a conventional pilot light. The use of a single igniter 66 is preferred as it reduces the overall cost and complexity of the system. However, other embodiments utilize multiple igniters, similar to those utilized in conventional propane gas grills, which are each in communication with a single infrared chamber and are controlled by the control box 18 of FIG. 1. In still other embodiments, there are no igniters and an operator manually ignites the fuel within each infrared chamber.

Finally, the embodiment of FIG. 5 include one hygrometer 70 for determining the moisture content of the aggregate at the at least the start of the preheating process and another hygromgeter 70 at the end of the preheating process. In such embodiments, the hygrometers are in communication with a conveyor control (not shown), which slows the conveyor belt 12 or speeds up the conveyor belt 12 based upon the amount of moisture within the aggregate material 22. Thus use of such a control is preferred in when the system is used in connection with warm melt asphalt manufacturing as it allows for careful control of the amount of moisture while maximizing the speed of the process in instances where there are minimal amounts of moisture within the aggregate. In other embodiments, the hygrometer is replaced by a thermometer, which measures the temperature of the aggregate material 22 and controls the speed of the conveyer belt 12 accordingly.

In operation, the conveyor belt 12 conveys the aggregate material 22 from its source and under the infrared chambers 14 at a predetermined rate. The fuel 16 flows to the infrared chambers 14, which burn the fuel 16 causing the infrared chambers 14 to emit infrared radiation therefrom. The infrared radiation contacts the top surface of the aggregate 22 that is conveyed on the conveyor belt and acts to heat the top portion 40 of the aggregate material 22 proximate to said infrared chambers 14. The mixer 20 then mixes the aggregate material 20 such that heated layer 40 and unheated layer 42 of aggregate material 20 are mixed together, allowing the unheated aggregate material proximate to the conveyor belt to rise to the top surface proximate to the infrared chamber. The infrared radiation from the infrared chamber 14 then heats the mixed aggregate material 44 to effectively pre-heat and pre-dry the aggregate material 44.

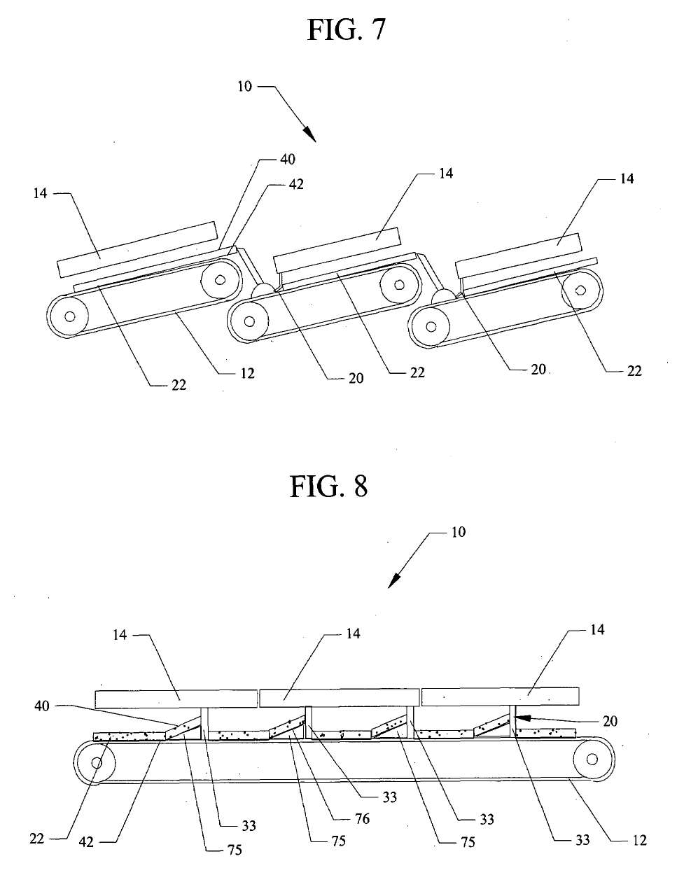

Experimentation with the system 10 of the present invention has shown that, although the mixers 20 of FIGS. 1-5 work well with non-recycled asphalt aggregate, they are not always effective when used in connection with recycled asphalt aggregate. Accordingly, the inventor developed the alternative systems 10 shown in FIGS. 7 and 8. The system 10 of FIG. 7 utilizes multiple conveyor belts 12 that are spaced apart to allow the aggregate 22 to tumble from one conveyor belt 12 to the adjacent conveyor belt 12. Once tumbled, the aggregate is mixed preferably by moving through the tines 33 of a mixer 20, which is shown as the mixer described in connection with FIGS. 1-4 but may take the form of any of the mixers 20 described herein. This method is preferred in connection with the use of recycled asphalt aggregate material 22 as the tumbling of the aggregate material 20 facilitates the release of moisture therefrom and allows the aggregate to be heated to lower temperatures than would otherwise be necessary to effect drying. This lower temperature heating prevents the asphalt material within the aggregate from changing to a liquid state, which reduces the risk both clumping of the material and of the asphalt igniting during the drying process.

FIG. 8 shows an alternative embodiment of the system of FIG. 7 in which the tumbling action caused by multiple belts 12 is achieved through the use a series of ramps 75 that are disposed proximate to the conveyor belt 12. The ramps 75 each include a ramp surface 76 that is disposed at an angle from a plane formed by the conveyor belt 12 and is dimensioned to allow the recycled asphalt aggregate 22 to pushed up the ramp by aggregate 22 that is in contact with the conveyor belt 12 and to tumble back onto the belt 12, effectively mixing the heated portion 40 of the aggregate 12 and the unheated portion 42 of the aggregate material 22 together. As shown in FIG. 7, once tumbled the aggregate material 22 passes through a mixer 20, which further mixes the aggregate material 22. The embodiment of FIG. 6 shows four ramps 75 that are equally spaced. However, any number of ramps 75 maybe utilized and these ramps may be spaced at any distance apart.

The system 10 of the present invention may be sold in a kit form for inclusion in existing manufacturing processes. Such kits include the infrared chamber(s) 14 and the mixer(s) 20 and are adapted to be installed in asphalt manufacturing plants with existing conveyor belts. Other embodiments of the preheating kit may include any of the options discussed above in connection with the system, and may also include a source of fuel 16.

The invention also includes a method for pre-drying an aggregate material for use in an asphalt manufacturing process. In its most basic form, the method includes the steps of conveying an aggregate material under a source of infrared radiation, first heating a portion of said aggregate material using infrared radiation, mixing said heated portion of said aggregate material with an unheated portion of said aggregate material, and second heating said mixed aggregate material.

The preferred method includes eight heating steps and six mixing steps. Some embodiments of the method also include the steps of measuring the moisture content and/or temperature of the aggregate and controlling the speed of the conveyor belt based upon a result of the measuring step.

Although the present invention has been described in considerable detail with reference to certain preferred versions thereof, other versions would be readily apparent to those of ordinary skill in the art. Further, although the invention was developed for use in connection with aggregates used as paving materials, it is readily adapted for use with aggregates used for other purposes, such as livestock feed, or the like. Therefore, the spirit and scope of the appended claims should not be limited to the description of the preferred versions contained herein.

1. A system for heating an aggregate material, said system comprising:
a conveyor belt in communication with a source of the aggregate material, wherein said conveyor belt is adapted to convey said aggregate material at a predetermined rate;
at least one infrared chamber disposed in substantially parallel relation to said conveyor belt at a distance sufficient to allow infrared heating of the aggregate material;
a source of fuel in communication with said infrared chamber;
at least one mixer disposed between said infrared chamber and said conveyor belt, said mixer being dimensioned and disposed relative to said conveyor belt so as to mix the aggregate material during pre-drying;
wherein said conveyor belt conveys the aggregate material under said infrared chamber, said fuel flows to said at least one infrared chamber, said infrared chamber bums said fuel causing said infrared chamber to emit infrared radiation therefrom, said infrared radiation heat a portion of the aggregate material proximate to said infrared chamber, said at least one mixer mixes the aggregate material such that heated and unheated aggregate material are mixed together, and said infrared radiation heats the mixed aggregate material to effectively pre-dry the aggregate material.

2. The system as claimed in claim 1 further comprising a control box in electrical communication with said infrared chamber, and said source of fuel, said control box comprising controls for controlling the flow of fuel from said source of fuel to said infrared chamber.

3. The system as claimed in claim 2 further comprising at least one blower motor in communication with said control box, said source of fuel, a source of air, and said infrared chamber, wherein said blower motor is controlled by said control box, mixes fuel and air together, and forces said mixture of fuel and air into said infrared chamber.

4. The system as claimed in claim 1 wherein said system comprises at least one igniter in communication with said infrared chamber and adapted to ignite said fuel within said infrared chamber.

5. The system as claimed in claim 4 wherein said system comprises at least two infrared chambers and wherein said igniter comprises a single igniter in communication with each of said at least two infrared chambers and adapted to ignite said fuel within each of said at least two infrared chambers.

6. The system as claimed in claim 1 wherein each infrared chamber comprises a plurality of infrared energy converters, wherein said at least one mixer comprises a plurality of mixers, wherein one mixer is disposed between adjacent infrared energy converters, wherein each mixer comprises a plurality of tines disposed at an angle relative to the an angle of travel of said conveyor belt, and wherein said plurality of tines of one mixer are arranged at a different angle from said plurality of tines of an adjacent mixer.

7. The system as claimed in claim 1 wherein said at least one mixer comprises at least two mixers, wherein each of said at least two mixers comprises a plurality of tines forming a plurality of spaces therebetween, and wherein each of said at least two mixers is dimensioned and disposed such that each of said tines of a first of said at least two mixers is aligned with a space of a second of said at least two mixers.

8. The system as claimed in claim 1 wherein said at least one mixer comprises a channel, a plurality of tines rotatably attached to said channel and at least one spring in communication with said plurality of tines, wherein said plurality of tines are disposed in sufficiently close proximity to said conveyor belt so as to contact said aggregate material conveyed by said conveyor belt.

9. The system as claimed in claim 1 wherein said at least one mixer comprises at least one ramp disposed proximate to said conveyor belt, wherein said at least one ramp comprises a ramp surface disposed at an angle from plane formed by said conveyor belt and dimensioned to allow said asphalt aggregate to pushed up said ramp by aggregate that is in contact with said conveyor belt and to tumble back onto the belt.

10. The system as claimed in claim 1 wherein said at least one infrared chamber comprises a top surface that allows moisture to escape therethrough.

11. The system as claimed in claim 1 further comprising at least one hygrometer disposed so as to detect an amount of moisture within said aggregate material and at least one conveyor belt control; wherein said at least one hygrometer is in electrical communication with said conveyor belt control and wherein said conveyor belt control is adapted to accept a signal from said hygrometer and to control a speed of said conveyor belt based upon said signal from said hygrometer.

12. The system as claimed in claim 1 further comprising at least one thermometer disposed so as to detect an temperature of said aggregate material and at least one conveyor belt control; wherein said at least one thermometer is in electrical communication with said conveyor belt control and wherein said conveyor belt control is adapted to accept a signal from said thermometer and to control a speed of said conveyor belt based upon said signal from said thermometer.

13. A heating kit for integration with a source of fuel and a conveyor belt for conveying an aggregate material; said kit comprising:
at least one infrared chamber dimensioned for disposal in communication with the source of fuel and in substantially parallel relation to the conveyor belt at a distance sufficient to allow infrared heating of the aggregate material; and
at least one mixer dimensioned for disposal between said infrared chamber and the conveyor belt, said mixer being dimensioned for disposal relative to the conveyor belt so as to mix the aggregate material during pre-drying;
wherein said at least one infrared chamber is disposed in substantially parallel relation to the conveyor belt, said mixer is disposed relative to the conveyor belt so as to mix the aggregate material during pre-drying, the conveyor belt conveys the aggregate material under said infrared chamber, fuel flows to said at least one infrared chamber, said infrared chamber burns the fuel causing said infrared chamber to emit infrared radiation therefrom, said infrared radiation heat a portion of the aggregate material proximate to said infrared chamber, said at least one mixer mixes the aggregate material such that heated and unheated aggregate material are mixed together, and said infrared radiation heats the mixed aggregate material to effectively pre-dry the aggregate material.

14. The kit as claimed in claim 13 further comprising a control box for disposal in electrical communication with said infrared chamber and said source of fuel, said control box comprising controls for controlling the flow of fuel from said source of fuel to said infrared chamber.

15. The kit as claimed in claim 14 further comprising at least one blower motor for disposal in communication with said control box, said source of fuel, a source of air, and said infrared chamber, wherein said blower motor is adapted to be controlled by said control box, mix fuel and air together, and force said mixture of fuel and air into said infrared chamber.

16. The kit as claimed in claim 13 further comprising at least one igniter for disposal in communication with said infrared chamber and adapted to ignite said fuel within said infrared chamber.

17. The kit as claimed in claim 13 wherein each infrared chamber comprises a plurality of infrared energy converters, wherein said at least one mixer comprises a plurality of mixers, wherein one mixer is disposed between adjacent infrared energy converters, wherein each mixer comprises a plurality of tines disposed at an angle relative to the an angle of travel of the conveyor belt, and wherein said plurality of tines of one mixer are arranged at a different angle from said plurality of tines of an adjacent mixer.

18. The kit as claimed in claim 13 wherein said at least one mixer comprises at least one ramp disposed proximate to said conveyor belt, wherein said at least one ramp comprises a ramp surface disposed at an angle from plane formed by said conveyor belt and dimensioned to allow said asphalt aggregate to pushed up said ramp by aggregate that is in contact with said conveyor belt and to tumble back onto the belt.

19. The kit as claimed in claim 13 wherein said at least one infrared chamber comprises a top surface that allows moisture to escape therethrough.

20. A method for pre-drying an aggregate material for use in an asphalt manufacturing process, said method comprising the steps of:
conveying an aggregate material under a source of infrared radiation;
first heating a portion of said aggregate material using infrared radiation;
mixing said heated portion of said aggregate material with an unheated portion of said aggregate material; and
second heating said mixed aggregate material.
